(19) United States
(12) Patent Application Publication
(10) Pub. No.: US 2013/0047749 A1
(43) Pub. Date: Feb. 28, 2013

(54) AUTONOMOUS PROCESS INSTRUMENT FLUSHING

(71) Applicants: Ralf Leidner, Fort Collins, CO (US); Murphy Pickard, Broomfield, CO (US)

(72) Inventors: Ralf Leidner, Fort Collins, CO (US); Murphy Pickard, Broomfield, CO (US)

(73) Assignee: Hach Company, Loveland, CO (US)

(21) Appl. No.: 13/593,731

(22) Filed: Aug. 24, 2012

Related U.S. Application Data
(60) Provisional application No. 61/526,974, filed on Aug. 24, 2011.

(51) Int. Cl. G01N 1/10

(52) U.S. Cl. 73/863.01

(57) ABSTRACT

An aspect provides a method of autonomously flushing a process instrument, including: providing a sample fluid to a measurement chamber of the process instrument; providing a measurement agent to the sample; and responsive to a predetermined flushing condition, flowing measurement agent free fluid through the measurement chamber. Other aspects are described and claimed.

### CLAIM FOR PRIORITY

This application claims priority to U.S. Provisional Application No. 61/526,974, filed on Aug. 24, 2011 and entitled “AUTONOMOUS SENSOR FLUSHING SYSTEM DEVICE AND METHOD”, which is incorporated by reference here in its entirety.

### BACKGROUND

Monitoring the characteristics of a liquid is desirable in many industries. For example, measuring water characteristics in industrial processes is a requirement for many governmental agencies such as the Environmental Protection Agency (EPA) and the Food Drug Administration (FDA).

Process instruments are utilized in a variety of commercial contexts, for example in water treatment applications. Disinfecting or other treatment of the water may in turn lead to a need to neutralize or otherwise deactivate the disinfectant or treatment agent(s). Process instruments are useful in this regard, as they allow for accurate monitoring of chemical levels, such as chlorine levels, remaining in a fluid sample. An example of a process instrument in this regard is a colorimetric meter or sensor instrument, such as the 1735 TRO Analyzer of Hach Company (Loveland, Colo.), that measures oxidizer (for example, chlorine) content in water using a color indicator or agent, such as diethyl-p-phenylene diamine (DPD).

Typical process instruments, such as colorimetric measurement instruments for analyzing water are designed to run continuously for an extended period of time. These instruments generally require a manual shut down procedure to avoid damage or problems, for example if they are to be shut down for a period of time. A shut down procedure generally involves rinsing or emptying of fluidics among other tasks. This use model is generally accepted in current markets where the instruments are only shut down when they will be removed and stored.

### BRIEF SUMMARY

An embodiment provides a process instrument that is able to autonomously put itself in or otherwise maintain a state that is appropriate for extended storage or shut down, for example on the order of weeks, even if abruptly shut down (unplanned or improper shut down). An embodiment also provides a process instrument that is able to successfully re-start without user intervention after such an unplanned and extended shut down. An embodiment provides for flushing fluid, whether fresh sample fluid or flushing fluid from a reservoir that is run through certain components of the process instrument. An example of such an embodiment includes a measurement chamber of a colorimeter, wherein after the colorimeter has been shut down or otherwise placed in a state where flushing of a component is appropriate, termed herein as “a predetermined flushing condition,” the colorimeter's measurement chamber is autonomously flushed in response to one or more predetermined flushing conditions being detected, such as a shut down of the instrument.

In summary, one aspect provides a method of autonomously flushing a process instrument, comprising: providing a sample fluid to a measurement chamber of the process instrument; providing a measurement agent to the sample; and responsive to a predetermined flushing condition, flowing measurement agent free fluid through the measurement chamber. For the purposes of this disclosure “measurement agent free fluid” shall mean fluid that is free or substantially free of a measurement agent.

Another aspect provides an autonomously flushing process instrument, comprising: a measurement chamber configured to measure a sample of fluid; a fluid source containing the sample and connected to the measurement chamber; a measurement agent source provided to the sample; and a valve configured to permit flow of sample not containing measurement agent to the measurement chamber responsive to a predetermined flushing condition.

A further aspect provides an autonomously flushing process instrument, comprising: a measurement chamber configured to receive a sample of fluid and a measurement agent; a measurement agent source connected to the measurement chamber; and a valve configured to permit flow of measurement agent free fluid to the measurement chamber responsive to a predetermined flushing condition.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example autonomous process instrument flushing system.

FIG. 2 illustrates another example autonomous process instrument flushing system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Existing process instruments are not well suited for use in certain contexts. For example, ships take on ballast water and may discharge ballast water within new territorial waters. Ships take on or discharge ballast water during cargo loading and unloading operations. Regulations are now being enacted that require ships to disinfect or otherwise treat the ballast water prior to discharging it, for example treatment with an oxidizer such as chlorine or bromine.

As typical process instruments are designed to run continuously for an extended period of time, a ship board use model for ballast water processing requires that the instrument run continuously for relatively short (8-24 hour) periods, and is shut off for longer periods (1-2 weeks) of time. This use context may cause damage or measurement problems for conventional process instruments. For example, a problem may arise when a process instrument is shut down abruptly at any point in its measuring cycle. In such a circumstance, damage or fouling to the measurement chamber may result from residual color indicator, such as DPD, or other chemical reagent remaining in the measurement chamber for extended periods without being properly flushed.

Accordingly, an embodiment provides a process instrument that is able to put itself in or otherwise maintain a state that is appropriate for extended storage or shut down, for example on the order of weeks, even if abruptly shut down (unplanned or improper shut down). An embodiment also provides a process instrument that is able to re-start successfully without user intervention after such an abrupt or unplanned and extended shut down.

An embodiment provides for establishing a reservoir of solution during operation, and then allowing that solution to run through certain components of the analyzer (for example, a measurement chamber of a colorimeter) after the instrument has been shut down, thereby, allowing the instrument to be flushed in response to one or more predetermined flushing conditions being detected, such as shut down of the instrument. Accordingly, embodiments are adapted for addressing new use contexts. For example, monitoring the treatment of ballast water on a ship has arisen from new regulations requiring disinfecting or treating of ballast water prior to discharge. Embodiments provide for automated resting of the process instrument, thus reducing the need for operator intervention in the shut down process.

The description now turns to the Figures. It should be noted that the figures illustrate non-limiting example embodiments.

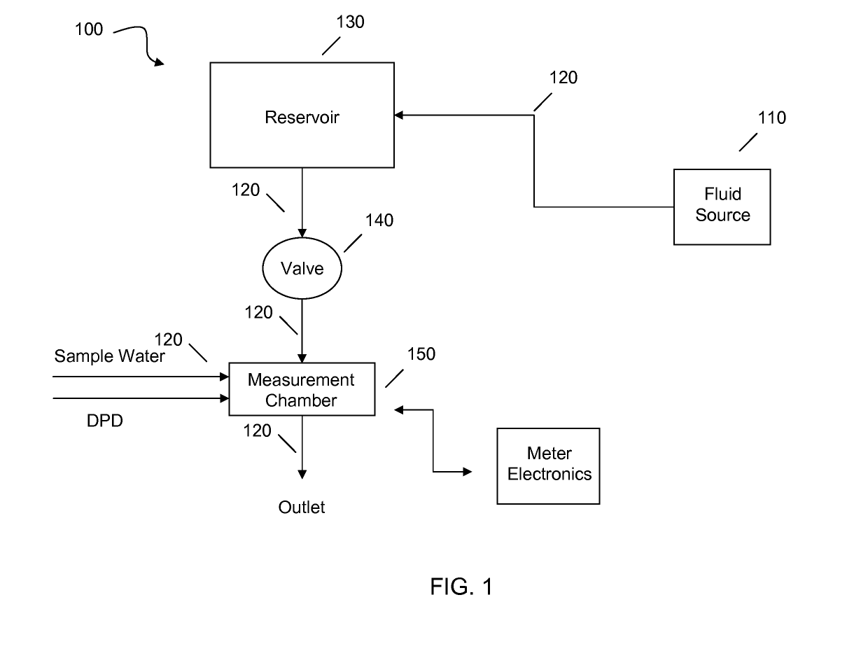

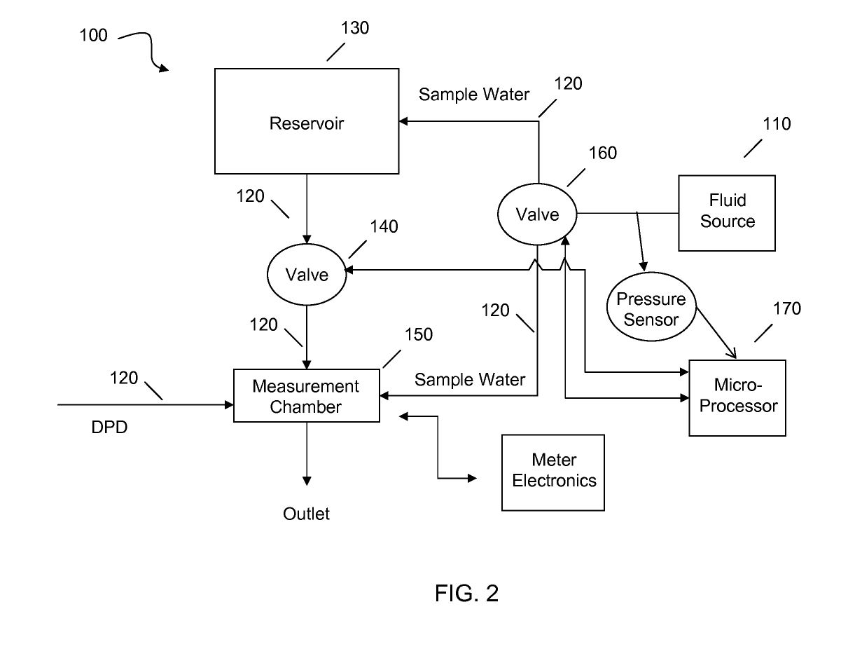

Referring to FIG. 1 and FIG. 2, an embodiment provides an autonomous flushing system 100 that establishes a reservoir 130 of some flushing solution from a fluid source 110. The flushing solution may take a variety of forms. For example, the flushing solution may be sample solution itself, such as ballast water, or a formulated flushing solution specially designed to clean a component, such as a measurement chamber, of a process instrument. The flushing solution originates from a fluid source 110 that may in turn take a variety of forms. For example, the fluid source 110 may be a ballast water tank, a tank of treated ballast water, or a reserve of flushing solution separate from the sample to be treated and measured. In any event, the flushing solution is transported from the fluid source 110 to the reservoir 130 via a fluid line 120.

The reservoir 130 may be filled with the flushing solution during operation of the process instrument 100 (that is, when the instrument is powered and operating to perform sample analysis). Alternatively, the reservoir 130 may be filled prior to running the instrument, periodically or intermittently. The reservoir 130 may then be drained of solution or flow solution through a component of the analyzer. A non-limiting example includes fluid from the reservoir 150 flowing through a measurement chamber 150 of a colorimeter responsive to a predetermined flushing condition, such as a shut down of the process instrument 100 or a portion thereof. Additionally, the reservoir 130 may be configured to flow fluid to the measurement chamber 150 when the power is removed from the sample.

An embodiment provides that the reservoir 130 is energized in some fashion such that it may provide fluid flow to a component such as measurement chamber 150 even if power is shut off to the instrument 100. For example, an embodiment provides that the reservoir 130 is maintained at a higher pressure than the outlet or drain of the measurement chamber 150 to be flushed so that the flushing solution will flow through the measurement chamber 150, even if the process instrument 100 or a component thereof is shut off. For example, an embodiment provides that the reservoir 130 will flow fluid through the measurement chamber 150 without pumps by virtue of pressure, either actively pressurized or in the form of gravity based flow due to the configuration/placement of the reservoir 130 in the system 100. This may be accomplished by using a reservoir 130 that is capable of maintaining some positive pressure, or by locating the reservoir such that it is above the measurement chamber 150 and relying on pressure to move the flushing solution via a fluid line 120 through the measurement chamber 150. In this manner, the reservoir 130 allows the flushing solution to run through the measurement chamber 150 when the process instrument 100 or a component thereof is de-energized.

For example, the process instrument 100 may incorporate a valve 140 such that when the process instrument 100 is de-energized, the valve 140 obtains its resting state, which is open, thereby allowing fluid to flow through it. In this way, the valve 140 permits flushing fluid stored in the reservoir 130 to flow to the measurement chamber 150, flushing the measurement chamber 150 and removing any color indicator, such as DPD in the non-limiting case of chlorine measurement, from fouling the measurement chamber 150.

The reservoir 130 may be filled or provided in a variety of ways. For example, using a pressurized line for the flushing solution may fill the reservoir 130. This pressurized line may be incorporate a valve 160, such as a 3-way valve, that allows that solution to flow to the reservoir 130 to fill it while the instrument 100 is operating and has power, or permit the fluid to flow to the measurement chamber 150, or a suitable combination of the foregoing. A microprocessor 170 may be provided to control the valve 160 to appropriately direct fluid either to the reservoir 130, the measurement chamber 150, or both. For example, the valve 160 may provide fluid flow to the measurement chamber 150 and/or the reservoir 130 in normal operation such that the reservoir 130 is filled. The 3-way valve may also provide fluid flow to the measurement chamber 150 rather than the reservoir by virtue of control provided by microprocessor 170.

If an operator shuts off sample fluid flow to the measurement chamber 150 without shutting off to color indicator supply to the measurement chamber 150, this creates a situation in which color indicator is provided to the measurement chamber without sample solution, creating a danger that the measurement chamber 150 may be fouled by excess color indicator. Thus, an embodiment may incorporate a pressure sensor or other sensor (for example, a fluid flow sensor) to indicate that the sample fluid is not flowing to the measurement chamber 150, but that a color indicator line is flowing to the measurement chamber 150. It should be noted that although the pressure sensor is indicated as placed on the fluid source line in FIG. 2, this is a non-limiting example, and the pressure sensor, or other sensor, may be placed in alternative or additional locations. Furthermore, it should be noted that more than one sensor or more than one sensor type may be used in variety of locations suitable for use in a process instrument.

Responsive to such a condition, an embodiment is configured to flow flushing fluid through the measurement chamber, shut the color indicator flow to the sample chamber 150 (for example, shutting a DPD containing solution line), such that the measurement chamber 150 is flushed and excess color indicator or other problematic agent is not introduced into measurement chamber 150 absent sample water. This may be provided in addition to the provision of a reservoir 130, as described herein.

The microprocessor 170 may provide control to other components, and may be integrated into meter electronics generally utilized for receiving, processing and displaying the measurement signals from the measurement chamber. Alternatively, more than one separate microprocessor sub-system may be provided to certain components of the system as desired to provide for separate, modular control of system components. The various electronic components (for example, microprocessor 170 and meter electronics) may communicate with one another via wired or wireless signal transmission such that the system may be integrated to provide for coordinated operation.

The reservoir 130 may be filled actively, for example with a pump. This may be accomplished when the instrument 100 proper is powered or by providing a separately powered sub component that operates autonomously from the instrument 100. Moreover, the reservoir 130 may be pre-filled, for example via utilization of a loadable, pressurized fluid cartridge into the system 100.

In the case of a pump, the flushing solution may be pumped from a separate container as compared with the sample to be tested in measurement chamber 150, or may be the sample itself (prior to treatment with color indicator or other potentially harmful chemical). As described herein, an autonomous sub component of may be provided to the instrument 100 such that, when an operator shuts off the power or shuts off sample flow to the chamber without shutting off color indicator inflow to the measurement chamber, the autonomous sub component autonomously flushes the measurement chamber. An example autonomous sub component may include a valve 140, a 3-way valve, an electrically controlled valve, or some suitable combination of the forgoing, that may respond to an appropriate signal (for example pressure drop in a fluid line, lack of power, and the like) in order to activate a flushing mechanism. Additionally, the autonomous sub component may be separately powered, for example by way of providing battery power or an alternative power supply, such that responsive to a signal indicating that a component or sub component of the process instrument 100 has been powered down or is otherwise not fully operating, the autonomous sub component retains power to perform a shut down operation, including flowing flushing fluid through the measurement chamber 150.

An embodiment provides that a reservoir may be provided not as a reserve container or tank, but rather as a fluid source that is made available at an appropriate time. For example, responsive to a shut down of the instrument 100, an embodiment may provide a reserve supply of fluid not from a reserve tank but rather by operating a value to supply an additional fluid line of flushing fluid. For example, an embodiment is configured not to use a reservoir tank but rather is configured to open a flushing fluid line, such as a pressurized water line, responsive to a shut down event. An additional fluid line or other fluid source may be utilized in addition to a separate reservoir tank 130.

Accordingly, embodiments provide devices, systems and arrangements that permit a measurement chamber of a process instrument to be flushed autonomously, without necessarily involving an operator. In this regard, an embodiment prevents the unnecessary fouling or damage to the measurement chamber, as may result from prolonged exposure to a color indicator such as DPD, if the process instrument is shut off or powered down and rested abruptly or without making a necessary flushing of the measurement chamber.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments have been described herein, it is to be understood that the embodiments are not limited to those precise embodiments, and that various other changes and modifications may be affected therein by one skilled in the art without departing from the scope or spirit of the disclosure.

What is claimed is:

1. A method of autonomously flushing a process instrument, comprising:
providing a sample fluid to a measurement chamber of the process instrument;
providing a measurement agent to the sample; and
responsive to a predetermined flushing condition, flowing measurement agent free fluid through the measurement chamber.

2. The method of autonomously flushing a process instrument of claim 1, wherein the measurement agent free fluid comprises sample fluid.

3. The method of autonomously flushing a process instrument of claim 1, wherein the measurement agent free fluid comprises flushing fluid.

4. The method of autonomously flushing a process instrument of claim 3, wherein the flushing fluid is derived from a reservoir.

5. The method of autonomously flushing a process instrument of claim 1, wherein the predetermined flushing condition comprises one or more of:
removal of power from at least one component of the process instrument;
flow of sample fluid rising or falling below a predetermined flow level;
pressure of sample fluid rising or falling below a predetermined pressure level;
removal of power from the process instrument; and
removal of sample flow to the measurement chamber without removal of measurement agent provision to the measurement chamber.

6. The autonomously flushing process instrument of claim 5, wherein the at least one component of the process instrument is a normally open valve.

7. The autonomously flushing process instrument of claim 5, wherein the at least one component of the process instrument is a three way valve.

8. The autonomously flushing process instrument of claim 7, further comprising a microprocessor operatively connected to the three way valve and configured to operate the three way valve to flow measurement agent free fluid to the measurement chamber responsive to the predetermined flushing condition.

9. The autonomously flushing process instrument of claim 1, wherein the measurement agent free fluid is derived from a pressurized water line.

10. An autonomously flushing process instrument, comprising:
a measurement chamber configured to measure a sample of fluid;
a fluid source containing the sample and connected to the measurement chamber;
a measurement agent source containing a measurement agent that is combined with the sample; and
a valve configured to permit flow of measurement agent free fluid to the measurement chamber responsive to a predetermined flushing condition.

11. The autonomously flushing process instrument of claim 10, wherein the valve is operatively connected to a processing component;
the processing component being configured to permit measurement agent free fluid to the measurement chamber responsive to a de-energizing signal.

12. The autonomously flushing process instrument of claim 10, wherein the processing component is separately powered from the autonomously flushing process instrument.

13. The autonomously flushing process instrument of claim 10, wherein the predetermined flushing condition comprises one or more of:
removal of power from at least one component of the process instrument;
flow of sample rising or falling below a predetermined flow level;
pressure of sample rising or falling below a predetermined pressure level;
removal of power from the process instrument; and
removal of sample flow to the measurement chamber without removal of measurement agent provision to the measurement chamber.

14. The autonomously flushing process instrument of claim 13, wherein the at least one component of the process instrument is a normally open valve.

15. The autonomously flushing process instrument of claim 13, wherein the at least one component of the process instrument is a three way valve.

16. The autonomously flushing process instrument of claim 15, further comprising a microprocessor operatively connected to the three way valve and configured to operate the three way valve to flow measurement agent free fluid to the measurement chamber responsive to the predetermined flushing condition.

17. An autonomously flushing process instrument, comprising:
a measurement chamber configured to receive a sample of fluid and a measurement agent;
a measurement agent source connected to the measurement chamber; and
a valve configured to permit flow of measurement agent free fluid to the measurement chamber responsive to a predetermined flushing condition.

18. The autonomously flushing process instrument of claim 17, further comprising a source containing the sample of fluid, wherein the source is connected to the measurement chamber.

19. The autonomously flushing process instrument of claim 18, wherein the source containing the sample of fluid is also the source of measurement agent free fluid.

20. The autonomously flushing process instrument of claim 17, further comprising a separate source of measurement agent free fluid.

21. The method of autonomously flushing a process instrument of claim 17, wherein the predetermined flushing condition comprises one or more of:
removal of power from at least one component of the process instrument;
flow of sample rising or falling below a predetermined flow level;
pressure of sample rising or falling below a predetermined pressure level;
removal of power from the process instrument; and
removal of sample flow to the measurement chamber without removal of measurement agent provision to the measurement chamber.

22. The autonomously flushing process instrument of claim 21, wherein the at least one component of the process instrument is a normally open valve.

23. The autonomously flushing process instrument of claim 21, wherein the at least one component of the process instrument is a three way valve.

24. The autonomously flushing process instrument of claim 23, further comprising a microprocessor operatively connected to the three way valve and configured to operate the three way valve to flow measurement agent free fluid to the measurement chamber responsive to the predetermined flushing condition.

25. The autonomously flushing process instrument of claim 17, wherein the measurement agent free fluid is derived from a pressurized water line.
